(19) United States
(12) Patent Application Publication
(10) Pub. No.: US 2026/0037609 A1
(43) Pub. Date: Feb. 5, 2026

(54) TRUSTED LOCATION BASED DEVICE AUTHENTICATION AND LOCKING

(71) Applicant: Motorola Mobility LLC, Chicago, IL (US)

(72) Inventors: Manju Mani, Bangalore (IN); Ranjeet Gupta, Aurora, IL (US); Birakayala Jagannadh Kumar, Bangalore (IN); Ajit Kumar Panda, Vernon Hills, IL (US)

(73) Assignee: Motorola Mobility LLC, Chicago, IL (US)

(21) Appl. No.: 18/791,200

(22) Filed: Jul. 31, 2024

(51) Int. Cl. G06F 21/40; G06F 21/32

(52) U.S. Cl. CPC G06F 21/40; G06F 21/32

(57) ABSTRACT

One or more of different types of authentication can be used to authenticate a user of an electronic device. Generally, the techniques discussed here describe using one type of authentication (single-factor authentication) in situations in which the electronic device is at a trusted location, and multiple types of authentication (e.g., multiple-factor authentication) in situations in which the electronic device is not at a trusted location (e.g., is at an untrusted location). If the electronic device is moved from a trusted location to a location that is not trusted while the electronic device is unlocked, the electronic device is locked to enforce multiple-factor authentication in the untrusted location.

### BACKGROUND

As technology has advanced electronic devices have become commonplace in our lives. For example, many people have cell phones and/or smart watches with them throughout the day. These electronic devices can be targets of thieves that can profit from the electronic device itself as well as confidential information stored on the electronic device (e.g., banking or money transfer passwords). Accordingly, it is beneficial to have our electronic devices protected against such theft.

### BRIEF DESCRIPTION OF THE DRAWINGS

Embodiments of trusted location based device authentication and locking are described with reference to the following drawings. The same numbers are used throughout the drawings to reference like features and components:

FIG. 1 illustrates an example mobile device implementing the techniques discussed herein;

FIG. 2 illustrates an example system implementing the techniques discussed herein;

FIGS. 3A and 3B illustrates an example of implementing the techniques discussed herein;

FIGS. 4 and 5 illustrate example processes for implementing the techniques discussed herein;

FIG. 6 illustrates various components of an example electronic device that can implement embodiments of the techniques discussed herein.

### DETAILED DESCRIPTION

Trusted location based device authentication and locking is discussed herein. One or more of different types of authentication can be used to authenticate a user of an electronic device. Generally, the techniques discussed here describe using one type of authentication (single-factor authentication) in situations in which the electronic device is at a trusted location, and multiple types of authentication (e.g., multiple-factor authentication) in situations in which the electronic device is not at a trusted location (e.g., is at an untrusted location). A trusted location refers to a location that is trusted by a user of the electronic device or that is a location that the user is expected to commonly have or use their electronic device. For example, a trusted location can be a geographic location (e.g., the user's home or the user's office) or can be a location where the electronic device is connected to another device trusted by or known to the user (e.g., a wireless headset, a Wi-Fi router).

In situations where the electronic device is not at a trusted location, multiple-factor authentication is used to log into or unlock the electronic device. This multiple-factor authentication includes, for example, biometric authentication and passcode authentication. If too many biometric authentication attempts fail (e.g., more than a threshold number of attempts within a threshold amount of time, such as more than 5 failed attempts within a 90-second time frame), the electronic device assumes that the device has been stolen or is otherwise not with the owner of the device, and activates a biometric lockout for the device. While the biometric lockout for the electronic device is activated, a user can log into or unlock the electronic device if both the biometric authentication and the passcode authentication are successful. However, while the biometric lockout for the electronic device is activated, a user cannot log into or unlock the electronic device if the biometric authentication and/or the passcode authentication is unsuccessful. Accordingly, if a thief or other rogue user was able to see the owner of the electronic device enter the correct personal identification number to unlock the electronic device, the thief or other rogue user would still not be able to unlock the electronic device because the biometric authentication will fail for the thief or rogue user.

On the other hand, in situations where the electronic device is at a trusted location, single-factor authentication is used to log into or unlock the electronic device. This single-factor authentication can be, for example, biometric authentication.

In contrast to techniques that allow for a user to enter a passcode to unlock the electronic device if biometric authentication fails, the techniques discussed herein do not allow the electronic device to be unlocked if biometric authentication fails when the electronic device is not at a trusted location (also referred to as the electronic device being at an untrusted location) even if the correct passcode is entered.

The techniques discussed herein improve the operation of an electronic device by enhancing the security of the electronic device when the electronic device is at an untrusted location. If a thief or other rogue user were to take the electronic device from the owner of the electronic device, the thief or other rogue user would be unable to unlock the phone based on entry of a passcode alone. Rather, the thief or other rogue user would need to successfully pass biometric authentication as well. As the thief or other rogue user would be unable to pass biometric authentication, the electronic device would remain locked.

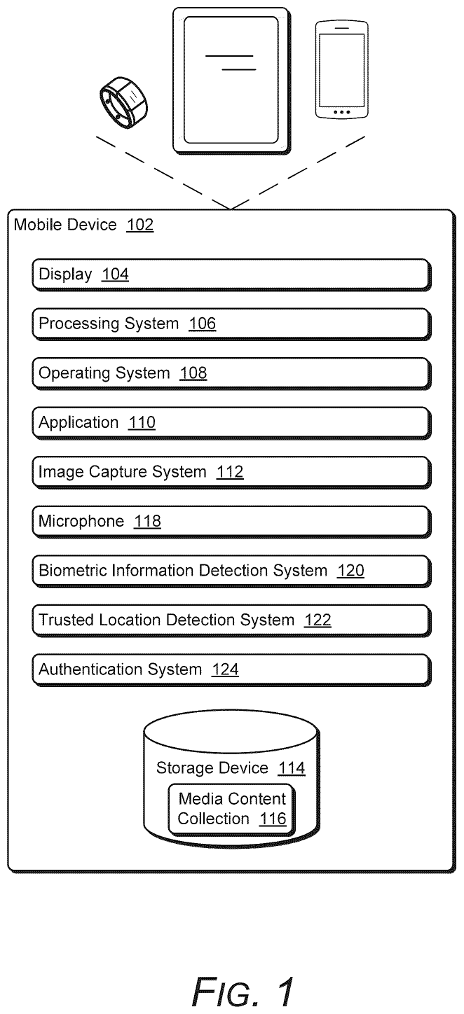

FIG. 1 illustrates an example mobile device 102 implementing the techniques discussed herein. The mobile device 102 can be, or include, many different types of computing or electronic devices. For example, the mobile device 102 can be a smartphone or other wireless phone, a camera (e.g., compact or single-lens reflex), or a tablet or phablet computer. By way of further example, the mobile device 102 can be a notebook computer (e.g., netbook or ultrabook), a laptop computer, a wearable device (e.g., a smartwatch, an augmented reality headset or device, a virtual reality headset or device), a personal media player, a personal navigating device (e.g., global positioning system), an entertainment device (e.g., a gaming console, a portable gaming device, a streaming media player, a digital video recorder, a music or other audio playback device), an Internet of Things (IoT) device, an automotive computer, and so forth.

The mobile device 102 includes a display 104. The display 104 can be configured as any suitable type of display, such as an organic light-emitting diode (OLED) display, active matrix OLED display, liquid crystal display (LCD), in-plane shifting LCD, projector, and so forth. Although illustrated as part of the mobile device 102, it should be noted that the display 104 can be implemented separately from the mobile device 102. In such situations, the mobile device 102 can communicate with the display 104 via any of a variety of wired (e.g., Universal Serial Bus (USB), IEEE 1394, High-Definition Multimedia Interface (HDMI)) or wireless (e.g., Wi-Fi, Bluetooth, infrared (IR)) connections. The display 104 can also optionally operate as an input device (e.g., the display 104 can be a touchscreen display).

The mobile device 102 also includes a processing system 106 that includes one or more processors, each of which can include one or more cores. The processing system 106 is coupled with, and may implement functionalities of, any other components or modules of the mobile device 102 that are described herein. In one or more embodiments, the processing system 106 includes a single processor having a single core. Alternatively, the processing system 106 includes a single processor having multiple cores or multiple processors (each having one or more cores).

The mobile device 102 also includes an operating system 108. The operating system 108 manages hardware, software, and firmware resources in the mobile device 102. The operating system 108 manages one or more applications 110 running on the mobile device 102, and operates as an interface between applications 110 and hardware components of the mobile device 102.

The mobile device 102 also includes an image capture system 112. The image capture system 112 captures images digitally using any of a variety of different technologies, such as a charge-coupled device (CCD) sensor, a complementary metal-oxide-semiconductor (CMOS) sensor, combinations thereof, and so forth. The image capture system 112 can include a single sensor and lens, or alternatively multiple sensors or multiple lenses. For example, the image capture system 112 may have at least one lens and sensor positioned to capture images from the front of the mobile device 102 (e.g., the same surface as the display is positioned on), and at least one additional lens and sensor positioned to capture images from the back of the mobile device 102.

The image capture system 112 can capture still images as well as video. The captured images or video are stored in a storage device 114 as a media content collection 116. The storage device 114 can be implemented using any of a variety of storage technologies, such as magnetic disk, optical disc, Flash or other solid state memory, and so forth.

The microphone 118 can be configured as any suitable type of microphone incorporating a transducer that converts sound into an electrical signal, such as a dynamic microphone, a condenser microphone, a piezoelectric microphone, and so forth.

The mobile device 102 also includes a biometric information detection system 120, a trusted location detection system 122, and an authentication system 124. Each of the biometric information detection system 120, the trusted location detection system 122, and the authentication system 124 can be implemented in a variety of different manners. For example, each of the systems 120, 122, and 124 can be implemented as multiple instructions stored on computer-readable storage media and that can be executed by the processing system 106. Additionally or alternatively, each of the systems 120, 122, and 124 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). One or more of the systems 120, 122, and 124 can be implemented in the same manner, or the systems 120, 122, and 124 can each be implemented in a different manner. Furthermore, although illustrated as separate from the operating system 108, one or more of the biometric information detection system 120, the trusted location detection system 122, and the authentication system 124 can be implemented at least in part as part of the operating system 108.

The biometric information detection system 120 detects various biometric information regarding the current user of the mobile device 102. The trusted location detection system 122 determines whether the mobile device 102 is currently in a trusted location or an untrusted location. The authentication system 124 determines whether to unlock the mobile device 102 based at least in part on whether the mobile device 102 is in a trusted location. This determination is made based on single-factor authentication or multiple-factor authentication as discussed in more detail below. If the authentication system 124 determines to unlock the mobile device 102, the authentication system 124 communicates (e.g., transmits or sends to a component of the operating system 108) an indication to unlock the mobile device. This allows the user of the mobile device 102 to access functionality provided by the operating system 108, the one or more applications 110, and so forth. If the authentication system 124 determines to not unlock the mobile device 102, the mobile device 102 remains locked (also referred to as being in a locked state). When locked, the user of the mobile device 102 is prevented from accessing functionality provided by the operating system 108, the one or more applications 110, and so forth.

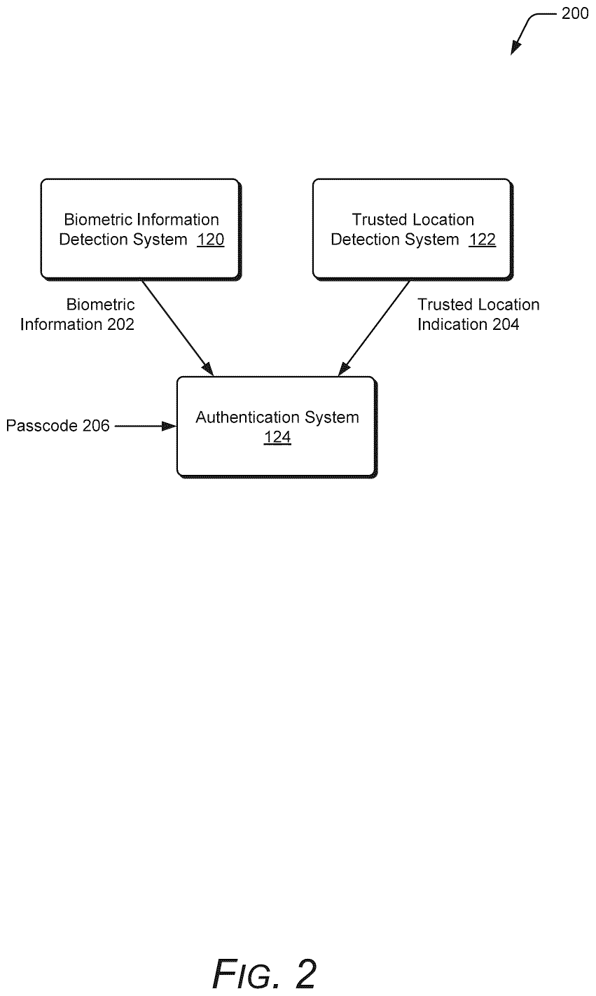

FIG. 2 illustrates an example system 200 implementing the techniques discussed herein. The biometric information detection system 120 detects various biometric information 202 regarding the current user of the mobile device 102. This biometric information 202 can be, for example, information describing the user's voice for voice recognition, facial features for face recognition, fingerprint features for fingerprint recognition, grip on the mobile device 102 for grip recognition, and so forth. Any of a variety of different public or proprietary techniques can be used to obtain the biometric information, and the particular techniques implemented by the biometric information detection system 120 can vary based on the particular biometric information that is obtained by the biometric information detection system 120.

For example, facial features can be obtained from a current image captured by the image capture system 112 and can include information regarding size or location of different aspects of a user's face, such as eyes, nose, mouth corners, ears, and so forth. By way of another example, fingerprint features can be obtained from a fingerprint sensor of the mobile device 102 (e.g., a capacitive scanner, an optical scanner, an ultrasonic scanner, the image capture system 112, etc.) and can include information regarding the pattern of ridges or lines on one or more of the user's fingers. By way of another example, voice input can be captured by the microphone 118 and can include information regarding different aspects of speech (e.g., phonemes) and the order and timing of the occurrence of those phonemes. By way of yet another example, touch features regarding how the user is touching or gripping the mobile device 102 can be obtained from one or more touch sensors distributed around the mobile device 102 (e.g., one or more pressure sensors, one or more capacitive sensors, one or more optical sensors, etc.) and can include information regarding the locations of the mobile device 102 being touched by the user, an amount of force applied by the user in touching different locations of the mobile device 102, and so forth.

The trusted location detection system 122 determines whether the mobile device 102 is currently in a trusted location or not in a trusted location (also referred to as an untrusted location). The trusted location detection system 122 can make this determination in various manners, such as based on a current geographic location of the mobile device 102, based on one or more devices (e.g., trusted devices) that the mobile device is connected to or within range of, and so forth. The current geographic location of the mobile device 102 can be determined in various manners, such as based on signals received from various satellites (e.g., using a global positioning system (GPS)), signals received from various other transmitters (e.g., base stations, Bluetooth Low Energy (BLE) transmitters transmitting their geographic locations), and so forth.

One or more geographic areas can be determined to be a trusted location. For example, as part of a registration process for the authorized user of the mobile device 102 the authorized user can specify certain geographic areas, such as the user's home, the user's workplace, the user's car, and so forth as trusted locations. The user can also optionally specify a distance corresponding to the trusted location. E.g., the user may specify that the trusted location is within a 20-yard radius of the user's home, withing a 20-yard radius of a geographic location that is associated with the user's home, and so forth.

One or more devices (e.g., trusted devices) that the mobile device 102 is connected to or within range of can be specified in various manners. For example, as part of a registration process for the authorized user of the mobile device 102, the authorized user can specify certain devices that are trusted devices. Examples of trusted devices include a wireless headset or wireless mouse, a Wi-Fi router, a BLE transmitter, another mobile device (e.g., a smartwatch), and so forth.

The authentication system 124 receives an indication 204 from the trusted location detection system 122 whether the mobile device 102 is in a trusted location or an untrusted location. The authentication system 124 can also receive from the biometric information detection system 120 the biometric information 202. The authentication system 124 can also receive a passcode 206 input by a user of the mobile device 102. The passcode 206 is an alphanumeric input or a pattern, such as a password, a personal identification number, a series of swipes or touches on a touchscreen, and so forth.

The authentication system 124 determines whether to use single-factor authentication or multiple-factor authentication based at least in part on whether the mobile device 102 is in a trusted location or an untrusted location. The user may also optionally enable or disable multiple-factor authentication. For example, the user can provide an input to the mobile device 102 indicating that multiple-factor authentication is to be used for the mobile device 102, or indicating that multiple-factor authentication is not to be used for the mobile device 102.

When using multiple-factor authentication, and optionally when using single-factor authentication, the authentication system 124 compares the biometric information 202 detected by the biometric information detection system 120 to authentication information previously provided by an authorized user (e.g., the owner) of the mobile device 102, also referred to as reference authentication information, to determine whether the biometric information 202 matches the reference authentication information. Whether the biometric information 202 matches the reference authentication information can be determined in different manners, such as determining whether the biometric information 202 is the same as the reference authentication information, determining whether there is at least a threshold probability (e.g., 90%) that the biometric information 202 and the reference authentication information identify the same user, and so forth. If the biometric information 202 matches the reference authentication information for the authorized user, then the authentication system 124 determines that biometric authentication of the user of the mobile device 102 is successful, also referred to as the biometric information 202 satisfies the biometric authentication (e.g., biometric authentication indicates that the authorized user is in possession of the mobile device 102). If the biometric information 202 does not match the reference authentication information for the authorized user, then the authentication system 124 determines that biometric authentication of the user of the mobile device 102 is unsuccessful (e.g., biometric authentication indicates that the authorized user is not in possession of the mobile device 102).

This reference authentication information can be provided to the mobile device 102, for example, as part of a registration or login process. The reference authentication information is maintained by the mobile device 102, such as in the storage device 114. By way of example, facial features or fingerprint features of the owner of the mobile device 102 can be obtained and stored as part of a registration process for the authorized user of the mobile device 102.

When using multiple-factor authentication, and optionally when using single-factor authentication, the authentication system 124 compares the received passcode 206 to a passcode previously provided by an authorized user (e.g., the owner) of the mobile device 102, also referred to as a reference passcode, to determine whether the passcode 206 matches the reference passcode. Whether the passcode 206 matches the reference passcode can be determined in different manners, such as determining whether the passcode 206 is the same as the reference authentication information, determining whether there is at least a threshold probability (e.g., 90%) that the passcode 206 and the reference passcode are the same, and so forth. If the passcode 206 matches the reference passcode for the authorized user, then the authentication system 124 determines that passcode authentication of the user of the mobile device 102 is successful, also referred to as the passcode 206 satisfies the passcode authentication (e.g., passcode authentication indicates that the authorized user is in possession of the mobile device 102). If the passcode 206 does not match the reference passcode for the authorized user, then the authentication system 124 determines that passcode authentication of the user of the mobile device 102 is unsuccessful (e.g., passcode authentication indicates that the authorized user is not in possession of the mobile device 102).

This reference passcode can be provided to the mobile device 102, for example, as part of a registration or login process. The passcode is maintained by the mobile device 102, such as in the storage device 114. By way of example, the personal identification number or input pattern for the owner of the mobile device 102 can be obtained and stored as part of a registration process for the authorized user of the mobile device 102.

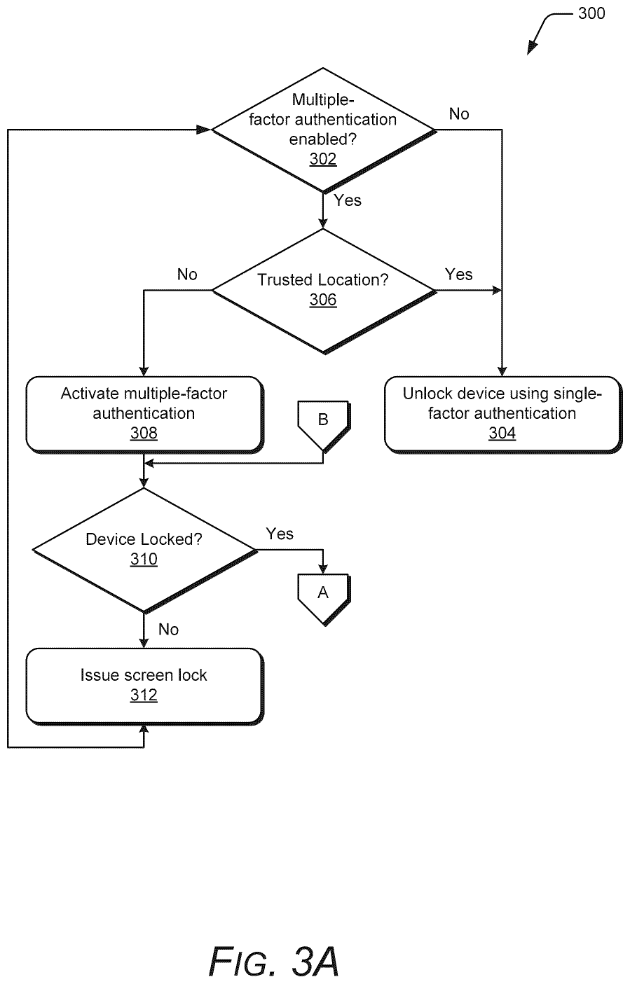

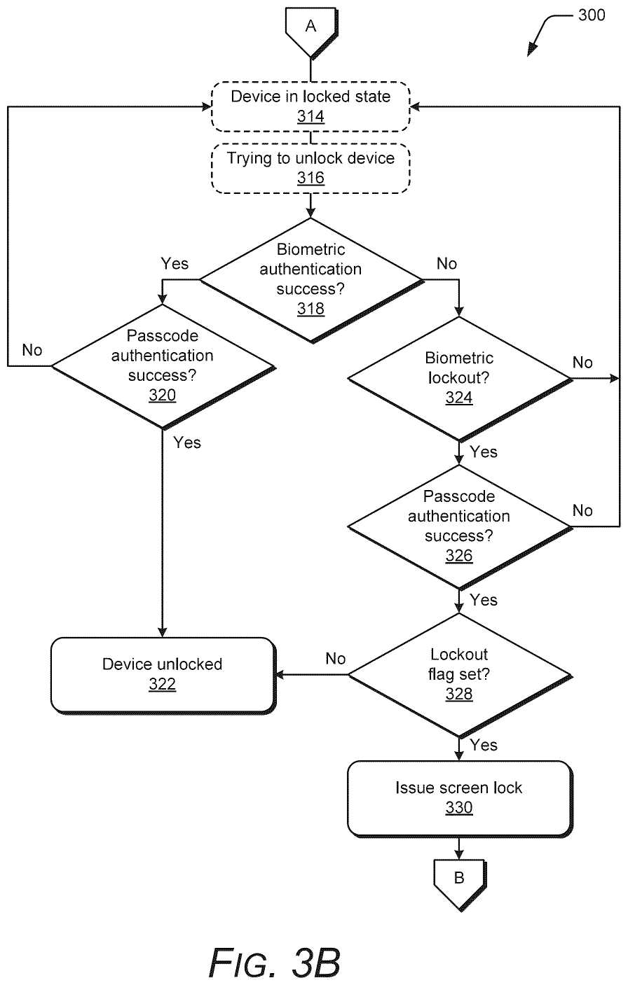

FIGS. 3A and 3B illustrates an example 300 of implementing the techniques discussed herein. The example 300 is implemented on an electronic device, such as mobile device 102 of FIG. 1. In the example 300, a check 302 is made as to whether multiple-factor authentication is enabled. Multiple-factor authentication can be enabled or disabled in response to various events or inputs, such as a user input requesting that multiple-factor authentication be enabled or disabled. If multiple-factor authentication is not enabled, then single-factor authentication is used 304 to unlock the mobile device.

If multiple-factor authentication is enabled, a check 306 is made as to whether the mobile device is at a trusted location. If the mobile device is at a trusted location, then single-factor authentication is used 304 to unlock the mobile device. If the mobile device is not at a trusted location, then multiple-factor authentication is activated 308. Multiple factor authentication remains activated, and is deactivated in response to the mobile device being moved to a trusted location.

A check 310 is made as to whether the mobile device is locked. If the mobile device is not locked a screen lock 312 is issued, causing the mobile device to be locked. Issuing a screen lock refers to, for example, issuing a command or request (e.g., to a component of the authentication system 124 or a component of the operating system 108). In response to issuing the screen lock, the authentication system 124 or a component of the operating system 108 locks the mobile device, causing a lock screen to be displayed (e.g., if a user attempts to use the mobile device). A check 302 as to whether multiple-factor authentication is enabled is then made.

If the check 310 indicates that the mobile device is locked, then the mobile device is in a locked state 314 and a user is attempting 316 to unlock the mobile device. A check 318 is made as to whether biometric authentication of the user was successful. If biometric authentication of the user was successful, then a check 320 is made as to whether passcode authentication of the user was successful. If passcode authentication was unsuccessful, then the mobile device remains in a locked state 314. If passcode authentication was successful, then the mobile device is unlocked 322.

If the check 318 indicates that biometric authentication of the user was not successful, a check 324 is made as to whether to lock out biometric authentication (also referred to as activate a biometric lockout). When biometric authentication is locked out a user can log into or unlock the electronic device if both the biometric authentication and the passcode authentication are successful. Biometric authentication is locked out in response to too many biometric authentication attempt failures. For example, if a user unsuccessfully attempts biometric authentication a threshold number of times in a threshold amount of time (e.g., 5 times in 90 seconds), biometric authentication is locked out. Biometric authentication remains locked out until one or more events occur (and is deactivated in response to one or more of those events occurring), such as the mobile device is moved to a trusted location.

If the check 324 indicates to lock out biometric authentication, then the mobile device remains in a locked state 314. If the check 324 indicates not to lock out biometric authentication, then a check 326 is made as to whether passcode authentication is successful. If passcode authentication is not successful, then the mobile device remains in a locked state 314.

If passcode authentication is successful, then a check 328 is made as to whether a lockout has occurred (e.g., a lockout flag has been set). A lockout can occur if biometric authentication has been locked out (e.g., when a certain number of consecutive finger or other biometric attestations fail). Additionally or alternatively, a lockout can occur a lockout can occur if passcode authentication has been locked out (e.g., when a certain number of consecutive passcode attempts fail). If no lockout has occurred (e.g., biometric authentication has not been locked out and passcode authentication has not been locked out), then the mobile device is unlocked 322. However, if a lockout has occurred (e.g., biometric authentication has been locked out and/or passcode authentication has been locked out), then a screen lock 330 is issued, causing the mobile device to remain locked.

Accordingly, using the techniques discussed herein, if a thief or rogue user has taken the mobile device and has been able to determine the passcode of the owner of the mobile device, biometric authentication for the thief or rogue user will be unsuccessful and the lock screen will remain issued. However, if the owner of the mobile device is in possession of the mobile device but biometric authentication fails a couple times (e.g., the user isn't looking at the mobile device from the proper angle), then biometric authentication for the owner will be successful, and if in an untrusted location the mobile device will be unlocked if the owner also enters the proper passcode.

Furthermore, if the mobile device is in an unlocked state and moves from a trusted location to a location that is not trusted, multiple-factor authentication is activated and the device is locked. Thus, if a thief or rogue user takes the owner's mobile device, once the thief or rogue user takes the mobile device outside of the trusted location, the mobile device is locked and multiple-factor authentication is used to authenticate the user to unlock the mobile device. As the thief or rogue user will be unable to pass biometric authentication, the thief or rogue user will be unable to unlock the mobile device.

Although discussed herein with reference to biometric authentication and passcode authentication, the techniques discussed herein can be used with other types of authentication, and may be used with three or more types of authentication.

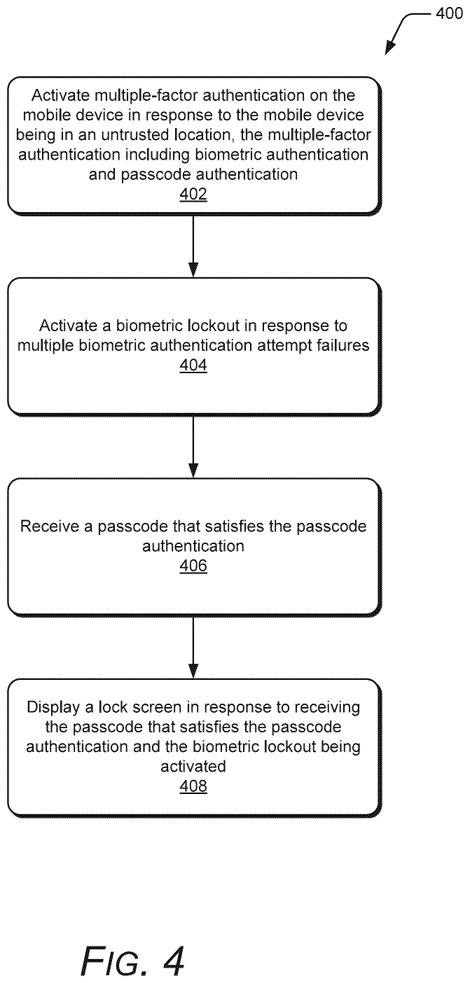

FIG. 4 illustrates an example process 400 for implementing the techniques discussed herein in accordance with one or more embodiments. Process 400 is carried out by various components of a mobile device or a system, such as biometric information detection system 120, trusted location detection system 122, and/or authentication system 124 of FIG. 1 or FIG. 2, and can be implemented in software, firmware, hardware, or combinations thereof. Process 400 is shown as a set of acts and is not limited to the order shown for performing the operations of the various acts.

In process 400, multiple-factor authentication on the mobile device is activated in response to the mobile device being in an untrusted location (act 402). The location is determined to be untrusted, for example, based at least in part on a geographic location of the mobile device or whether the mobile device is connected to a trusted device. The multiple-factor authentication includes, for example, biometric authentication and passcode authentication.

A biometric lockout is activated in response to multiple biometric authentication attempt failures (act 404). For example, the biometric lockout can be activated if a user unsuccessfully attempts biometric authentication a threshold number of times in a threshold amount of time (e.g., 5 times in 90 seconds).

A passcode that satisfies the passcode authentication is received (act 406). The passcode can be, for example, a password, a personal identification number, an input pattern, and so forth.

A lock screen is displayed in response to receiving the passcode that satisfies the passcode authentication and the biometric lockout being activated (act 408). Accordingly, when the biometric lockout is activated a lock screen is displayed, providing a passcode that satisfies the passcode authentication is not itself sufficient to unlock the mobile device.

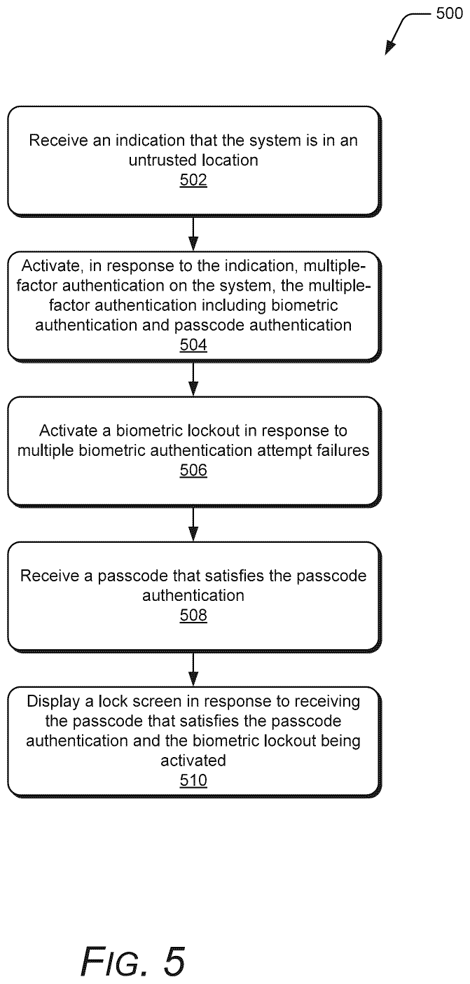

FIG. 5 illustrates an example process 500 for implementing the techniques discussed herein in accordance with one or more embodiments. Process 500 is carried out by various components of a mobile device or a system, such as biometric information detection system 120, trusted location detection system 122, and/or authentication system 124 of FIG. 1 or FIG. 2, and can be implemented in software, firmware, hardware, or combinations thereof. Process 500 is shown as a set of acts and is not limited to the order shown for performing the operations of the various acts.

In process 500, an indication that the system is in an untrusted location is received (act 502). The location is determined to be untrusted, for example, based at least in part on a geographic location of the system or whether the system is connected to a trusted device.

Multiple-factor authentication on the system is activated in response to the indication (act 504). The multiple-factor authentication includes, for example, biometric authentication and passcode authentication.

A biometric lockout is activated in response to multiple biometric authentication attempt failures (act 506). For example, the biometric lockout can be activated if a user unsuccessfully attempts biometric authentication a threshold number of times in a threshold amount of time (e.g., 5 times in 90 seconds).

A passcode that satisfies the passcode authentication is received (act 508). The passcode can be, for example, a password, a personal identification number, an input pattern, and so forth.

A lock screen is displayed in response to receiving the passcode that satisfies the passcode authentication and the biometric lockout being activated (act 510). Accordingly, when the biometric lockout is activated a lock screen is displayed, providing a passcode that satisfies the passcode authentication is not itself sufficient to unlock the system.

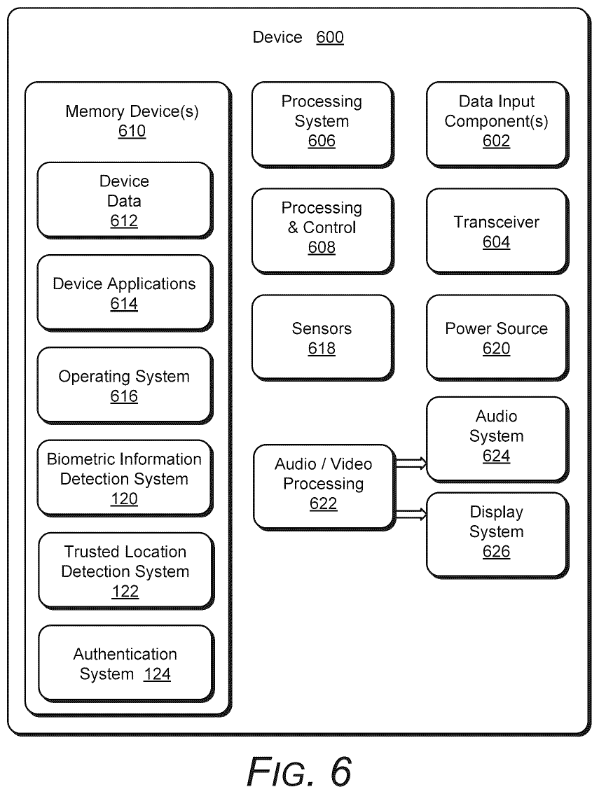

FIG. 6 illustrates various components of an example electronic device that can implement embodiments of the techniques discussed herein. The electronic device 600 can be implemented as any of the devices described with reference to the previous FIG.s, such as any type of client device, mobile phone, tablet, computing, communication, entertainment, gaming, media playback, or other type of electronic device. In one or more implementations, the electronic device 600 includes the biometric information detection system 120, the trusted location detection system 122, and the authentication system 124, described above.

The electronic device 600 includes one or more data input components 602 via which any type of data, media content, or inputs can be received such as user-selectable inputs, messages, music, television content, recorded video content, and any other type of text, audio, video, or image data received from any content or data source. The data input components 602 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 602 may also include various other input components such as microphones, touch sensors, touchscreens, keyboards, and so forth.

The device 600 includes communication transceivers 604 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 600 includes a processing system 606 of one or more processors (e.g., any of microprocessors, controllers, and the like) or a processor and memory system implemented as a system-on-chip (SoC) that processes computer-executable instructions. The processing system 606 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 608. The device 600 may further include any type of a system bus or other data and command transfer system that couples the various components within the device. A system bus can include any one or combination of different bus structures and architectures, as well as control and data lines.

The device 600 also includes computer-readable storage memory devices 610 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 610 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory device 610 provides data storage mechanisms to store the device data 612, other types of information or data, and various device applications 614 (e.g., software applications). For example, an operating system 616 can be maintained as software instructions with a memory device and executed by the processing system 606 to cause the processing system 606 to perform various acts. The device applications 614 may also include a device manager, such as any form of a control application, software application, signal-processing and control module, code that is native to a particular device, a hardware abstraction layer for a particular device, and so on.

The device 600 can also include one or more device sensors 618, such as any one or more of an ambient light sensor, a proximity sensor, a touch sensor, an infrared (IR) sensor, accelerometer, gyroscope, thermal sensor, audio sensor (e.g., microphone), fingerprint sensor, and the like. The device 600 can also include one or more power sources 620, such as when the device 600 is implemented as a mobile device. The power sources 620 may include a charging or power system, and can be implemented as a flexible strip battery, a rechargeable battery, a charged super-capacitor, or any other type of active or passive power source.

The device 600 additionally includes an audio or video processing system 622 that generates one or both of audio data for an audio system 624 and display data for a display system 626. In accordance with some embodiments, the audio/video processing system 622 is configured to receive call audio data from the transceiver 604 and communicate the call audio data to the audio system 624 for playback at the device 600. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for trusted location based device authentication and locking have been described in language specific to features or methods, the subject of the appended claims is not necessarily limited to the specific features or methods described. Rather, the specific features and methods are disclosed as example implementations of techniques for implementing trusted location based device authentication and locking. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a mobile device, including: at least one memory; and at least one processor coupled with the at least one memory and configured to cause the mobile device to: activate multiple-factor authentication on the mobile device in response to the mobile device being in an untrusted location, the multiple-factor authentication including biometric authentication and passcode authentication; activate a biometric lockout in response to multiple biometric authentication attempt failures; receive a passcode that satisfies the passcode authentication; display a lock screen in response to receiving the passcode that satisfies the passcode authentication and the biometric lockout being activated.

In some aspects, the techniques described herein relate to a mobile device, wherein the biometric authentication includes one or more of face recognition, fingerprint recognition, voice recognition, or grip recognition.

In some aspects, the techniques described herein relate to a mobile device, wherein the passcode includes one or more of a password, a personal identification number, or an input pattern.

In some aspects, the techniques described herein relate to a mobile device, wherein the at least one processor is further configured to cause the mobile device, in response to the mobile device being in a trusted location, to: deactivate the multiple-factor authentication on the mobile device; and deactivate the biometric lockout.

In some aspects, the techniques described herein relate to a mobile device, wherein the at least one processor is further configured to cause the mobile device to determine that the mobile device is in the trusted location based at least in part on a geographic location of the mobile device.

In some aspects, the techniques described herein relate to a mobile device, wherein the at least one processor is further configured to cause the mobile device to determine that the mobile device is in the trusted location based at least in part on the mobile device being connected to a trusted device.

In some aspects, the techniques described herein relate to a mobile device, wherein the at least one processor is further configured to cause the mobile device to lock the mobile device in response to detecting that the mobile device has been moved, while the mobile device is locked, from the trusted location to a location that is not trusted.

In some aspects, the techniques described herein relate to a method, including: activating multiple-factor authentication on a mobile device in response to the mobile device being in an untrusted location, the multiple-factor authentication including biometric authentication and passcode authentication; activating a biometric lockout in response to multiple biometric authentication attempt failures; receiving a passcode that satisfies the passcode authentication; and displaying a lock screen in response to receiving the passcode that satisfies the passcode authentication and the biometric lockout being activated.

In some aspects, the techniques described herein relate to a method, wherein the biometric authentication includes one or more of face recognition, fingerprint recognition, voice recognition, or grip recognition.

In some aspects, the techniques described herein relate to a method, wherein the passcode includes one or more of a password, a personal identification number, or an input pattern.

In some aspects, the techniques described herein relate to a method, further including, in response to the mobile device being in a trusted location, to: deactivating the multiple-factor authentication on the mobile device; and deactivating the biometric lockout.

In some aspects, the techniques described herein relate to a method, further including determining that the mobile device is in the trusted location based at least in part on a geographic location of the mobile device.

In some aspects, the techniques described herein relate to a method, further including determining that the mobile device is in the trusted location based at least in part on the mobile device being connected to a trusted device.

In some aspects, the techniques described herein relate to a method, further including locking the mobile device in response to detecting that the mobile device has been moved, while the mobile device is locked, from the trusted location to a location that is not trusted.

In some aspects, the techniques described herein relate to a system, including: at least one memory; and at least one processor coupled with the at least one memory and configured to cause the system to: receive an indication that the system is in an untrusted location; activate, in response to the indication, multiple-factor authentication on the system, the multiple-factor authentication including biometric authentication and passcode authentication; activate a biometric lockout in response to multiple biometric authentication attempt failures; receive a passcode that satisfies the passcode authentication; have a lock screen displayed in response to receiving the passcode that satisfies the passcode authentication and the biometric lockout being activated.

In some aspects, the techniques described herein relate to a system, wherein the biometric authentication includes one or more of face recognition, fingerprint recognition, voice recognition, or grip recognition.

In some aspects, the techniques described herein relate to a system, wherein the passcode includes one or more of a password, a personal identification number, or an input pattern.

In some aspects, the techniques described herein relate to a system, wherein the at least one processor is further configured to cause the system, in response to the system being in a trusted location, to: deactivate the multiple-factor authentication on the system; and deactivate the biometric lockout.

In some aspects, the techniques described herein relate to a system, wherein the at least one processor is further configured to cause the system to determine that the system is in the trusted location based at least in part on a geographic location of the system.

In some aspects, the techniques described herein relate to a system, wherein the at least one processor is further configured to cause the system to lock the system in response to detecting that the system has been moved, while the system is locked, from the trusted location to a location that is not trusted.

What is claimed is:

1. A mobile device, comprising:
at least one memory; and
at least one processor coupled with the at least one memory and configured to cause the mobile device to:
activate multiple-factor authentication on the mobile device in response to the mobile device being in an untrusted location, the multiple-factor authentication including biometric authentication and passcode authentication;
activate a biometric lockout in response to multiple biometric authentication attempt failures;
receive a passcode that satisfies the passcode authentication;
display a lock screen in response to receiving the passcode that satisfies the passcode authentication and the biometric lockout being activated.

2. The mobile device of claim 1, wherein the biometric authentication comprises one or more of face recognition, fingerprint recognition, voice recognition, or grip recognition.

3. The mobile device of claim 1, wherein the passcode comprises one or more of a password, a personal identification number, or an input pattern.

4. The mobile device of claim 1, wherein the at least one processor is further configured to cause the mobile device, in response to the mobile device being in a trusted location, to:
deactivate the multiple-factor authentication on the mobile device; and
deactivate the biometric lockout.

5. The mobile device of claim 4, wherein the at least one processor is further configured to cause the mobile device to determine that the mobile device is in the trusted location based at least in part on a geographic location of the mobile device.

6. The mobile device of claim 4, wherein the at least one processor is further configured to cause the mobile device to determine that the mobile device is in the trusted location based at least in part on the mobile device being connected to a trusted device.

7. The mobile device of claim 4, wherein the at least one processor is further configured to cause the mobile device to lock the mobile device in response to detecting that the mobile device has been moved, while the mobile device is locked, from the trusted location to a location that is not trusted.

8. A method, comprising:
activating multiple-factor authentication on a mobile device in response to the mobile device being in an untrusted location, the multiple-factor authentication including biometric authentication and passcode authentication;
activating a biometric lockout in response to multiple biometric authentication attempt failures;
receiving a passcode that satisfies the passcode authentication; and
displaying a lock screen in response to receiving the passcode that satisfies the passcode authentication and the biometric lockout being activated.

9. The method of claim 8, wherein the biometric authentication comprises one or more of face recognition, fingerprint recognition, voice recognition, or grip recognition.

10. The method of claim 8, wherein the passcode comprises one or more of a password, a personal identification number, or an input pattern.

11. The method of claim 8, further comprising, in response to the mobile device being in a trusted location, to:
deactivating the multiple-factor authentication on the mobile device; and
deactivating the biometric lockout.

12. The method of claim 11, further comprising determining that the mobile device is in the trusted location based at least in part on a geographic location of the mobile device.

13. The method of claim 11, further comprising determining that the mobile device is in the trusted location based at least in part on the mobile device being connected to a trusted device.

14. The method of claim 11, further comprising locking the mobile device in response to detecting that the mobile device has been moved, while the mobile device is locked, from the trusted location to a location that is not trusted.

15. A system, comprising:
at least one memory; and
at least one processor coupled with the at least one memory and configured to cause the system to:
receive an indication that the system is in an untrusted location;
activate, in response to the indication, multiple-factor authentication on the system, the multiple-factor authentication including biometric authentication and passcode authentication;
activate a biometric lockout in response to multiple biometric authentication attempt failures;
receive a passcode that satisfies the passcode authentication;
have a lock screen displayed in response to receiving the passcode that satisfies the passcode authentication and the biometric lockout being activated.

16. The system of claim 15, wherein the biometric authentication comprises one or more of face recognition, fingerprint recognition, voice recognition, or grip recognition.

17. The system of claim 15, wherein the passcode comprises one or more of a password, a personal identification number, or an input pattern.

18. The system of claim 15, wherein the at least one processor is further configured to cause the system, in response to the system being in a trusted location, to:
deactivate the multiple-factor authentication on the system; and
deactivate the biometric lockout.

19. The system of claim 18, wherein the at least one processor is further configured to cause the system to determine that the system is in the trusted location based at least in part on a geographic location of the system.

20. The system of claim 18, wherein the at least one processor is further configured to cause the system to lock the system in response to detecting that the system has been moved, while the system is locked, from the trusted location to a location that is not trusted.
